(19) United States
(12) Patent Application Publication
(10) Pub. No.: US 2024/0055678 A1
(43) Pub. Date: Feb. 15, 2024

(54) TEMPERATURE MEASUREMENT APPARATUS FOR BATTERY CELL AND METHOD THEREFOR

(71) Applicant: LS ELECTRIC CO., LTD., Anyang-si, Gyeonggi-do (KR)

(72) Inventors: Hyung Suk CHOI, Anyang-si, Gyeonggi-do (KR); Woo Jung KANG, Anyang-si, Gyeonggi-do (KR)

(21) Appl. No.: 18/035,656

(22) PCT Filed: Dec. 21, 2021
(86) PCT No.: PCT/KR2021/019508

§ 371 Date: Oct. 11, 2023

(30) Foreign Application Priority Data
Dec. 21, 2020 (KR) 10-2020-0180257
Jun. 25, 2021 (KR) 10-2021-0083034

(51) Int. Cl. H01M 10/48; H01M 10/613; H01M 10/625

(52) U.S. Cl. CPC H01M 10/486; H01M 10/482; H01M 10/613; H01M 10/625; H01M 2220/20

(57) ABSTRACT

The present disclosure provides a temperature measurement apparatus comprising: a light collecting unit located in at least a partial area of one surface of at least one battery cell, and for collecting electromagnetic waves radiated from the at least one battery cell; a light receiver for receiving the collected electromagnetic waves; and a control unit for measuring a temperature of the at least partial area of the one surface of the at least one battery cell on the basis of the received electromagnetic waves.

### TECHNICAL FIELD

The present disclosure relates to a battery temperature measurement apparatus for a battery cell and a method thereof, and more particularly to a temperature measurement apparatus and a method thereof for acquiring temperature spectrums of a plurality of battery cells included in a battery for an electric vehicle and measuring the temperature of the battery cells.

### BACKGROUND ART

A battery for an electric vehicle generally has a structure in which a plurality of battery cells are disposed. There is a need to monitor the temperatures of a plurality of battery cells to prevent battery fire and ensure the safety of electric vehicles.

However, when temperature sensors are installed on all of the plurality of battery cells to monitor each temperature, there is a very uneconomical problem in terms of cost.

In addition, a method of monitoring the temperature of some of the battery cells by installing temperature sensors on some of the plurality of battery cells may be effective in terms of cost, but has a problem in that a risk of fire due to some battery cells whose temperature is not monitored increases.

Therefore, there is a need to efficiently measure the temperature of a plurality of battery cells.

### DISCLOSURE OF THE INVENTION

### Technical Problem

An object of the present disclosure is to provide a temperature measurement apparatus for determining a maximum or minimum value of temperature in at least a partial region of a battery cell based on an electromagnetic wave having a unique wavelength radiated by thermal energy generated in at least a partial region of at least one battery cell and determining whether the battery cell is maintained to be equal to or less than a reference value.

An object of the present disclosure is to provide a temperature measurement apparatus for taking up less space to receive electromagnetic waves radiated from at least a partial region of the battery cell by condensing electromagnetic waves radiated from at least one battery cell using a thin light guide plate.

An object of the present disclosure is to provide a temperature measurement apparatus for taking up less space to receive electromagnetic waves radiated from at least a partial region of the battery cell by condensing electromagnetic waves radiated from at least one battery cell using a light collecting structure with a wide angle of view.

### Technical Solution

A temperature measurement apparatus according to an embodiment of the present disclosure includes a light collector positioned in at least a partial region of one surface of at least one battery cell and configured to collect an electromagnetic wave radiated from the at least one battery cell, a light receiver configured to receive the collected electromagnetic wave, and a controller configured to measure a temperature of at least a partial region of one surface of the at least one battery cell based on the received electromagnetic wave.

The temperature measurement apparatus according to an embodiment of the present disclosure includes a controller configured to acquire temperature spectrum information based on the received electromagnetic wave and to measure a temperature of at least a partial region of one surface of the at least one battery cell based on the temperature spectrum information.

The temperature measurement apparatus according to an embodiment of the present disclosure includes a light collector including a light guide plate on which the electromagnetic wave radiated from the at least one battery cell is incident and that is configured to change a path of the incident electromagnetic wave to the light receiver.

The temperature measurement apparatus according to an embodiment of the present disclosure includes a light collector including a reflective member disposed on a surface opposite to a surface on which the electromagnetic wave is incident and configured to reflect or diffuse the electromagnetic wave.

The temperature measurement apparatus according to an embodiment of the present disclosure includes at least one light receiving sensor disposed on one side surface of the light guide plate and configured to detect an infrared region of the electromagnetic wave.

The temperature measurement apparatus according to an embodiment of the present disclosure includes the plurality of light receiving sensors, and the plurality of light receiving sensors are disposed on one side surface of the light guide plate at a predetermined interval.

The temperature measurement apparatus according to an embodiment of the present disclosure includes a light collector including a Fresnel lens positioned closer to the at least one battery cell than the light guide plate and configured to concentrate the electromagnetic wave radiated from the at least one battery cell.

The temperature measurement apparatus according to an embodiment of the present disclosure includes a Fresnel lens that has a greater horizontal or vertical length than the light guide plate.

The temperature measurement apparatus according to an embodiment of the present disclosure includes a light collector has a shape of which a width decreases from an opposite side to a side at which the light receiver is disposed toward a side at which the light receiver is disposed.

The temperature measurement apparatus according to an embodiment of the present disclosure includes a light receiver includes one light receiving sensor disposed on a side surface at which the width of the light collector decreases and configured to detect an infrared region of the electromagnetic wave.

The temperature measurement apparatus according to an embodiment of the present disclosure includes a controller configured to acquire intensity information for each wavelength based on the temperature spectrum information, and when a wavelength intensity equal to or greater than a preset intensity is detected at a wavelength equal to or less than a preset wavelength based on the intensity information for each wavelength, to determines that heat at a temperature equal to or greater than a reference value is generated from at least a partial region of the at least one battery cell.

The temperature measurement apparatus according to an embodiment of the present disclosure includes a light collector including a Fresnel lens positioned close to the at least one battery cell and configured to concentrate the electromagnetic wave radiated from the at least one battery cell, and a light receiver including at least one light receiving sensor positioned in a direction in which a focus of the Fresnel lens is formed.

The temperature measurement apparatus according to an embodiment of the present disclosure includes a light collector spaced apart from at least one surface of at least one battery cell and configured to collect electromagnetic waves radiated from at least one battery cell, a light receiver configured to receive the collected electromagnetic wave, and a controller configured to measure a temperature of at least a partial region of one surface of at least one battery cell based on the received electromagnetic wave.

The temperature measurement apparatus according to an embodiment of the present disclosure includes the plurality of battery cells.

The temperature measurement apparatus according to an embodiment of the present disclosure includes a light collector including a condensing lens configured to collect an electromagnetic wave radiated from at least one battery cell.

The temperature measurement apparatus according to an embodiment of the present disclosure includes a condensing lens having a cylindrical shape including a first opening with an opened upper portion and a second opening with an opened lower portion.

The temperature measurement apparatus according to an embodiment of the present disclosure includes a condensing lens in which an inclined portion having an inclined surface that is concaved inward to the second opening from the first opening is formed.

The temperature measurement apparatus according to an embodiment of the present disclosure includes a condensing lens including an inclined portion including a coating portion with a surface on which a paint having predetermined reflectivity is formed.

The temperature measurement apparatus according to an embodiment of the present disclosure includes a condensing lens in which a diameter of the first opening is larger than a diameter of the second opening, and the first opening is disposed to face one surface of at least one battery cell.

The temperature measurement apparatus according to an embodiment of the present disclosure may include a light receiver including a light receiving sensor configured to receive electromagnetic wave collected by the light collector and disposed on the second opening.

The temperature measurement apparatus according to an embodiment of the present disclosure incudes a light receiving sensor having a light receiving range that is equal to or less than the diameter of the first opening and is equal to or greater than the diameter of the second opening.

### Advantageous Effects

A temperature measurement apparatus according to an embodiment of the present disclosure may determine a maximum or minimum value of temperature in at least a partial region of a battery cell based on an electromagnetic wave having a unique wavelength radiated by thermal energy generated in at least a partial region of at least one battery cell and may determine whether the battery cell is maintained to be equal to or less than a reference value.

The present disclosure may provide a temperature measurement apparatus for taking up less space to receive electromagnetic waves radiated from at least a partial region of the battery cell by condensing electromagnetic waves radiated from at least one battery cell using a thin light guide plate.

The temperature measurement apparatus according to an embodiment of the present disclosure may take up less space to receive electromagnetic waves radiated from at least a partial region of the battery cell by condensing electromagnetic waves radiated from at least one battery cell using a light collecting structure with a wide angle of view.

### BRIEF DESCRIPTION OF THE DRAWINGS

FIG. 1 is a diagram showing a conventional general backlight unit.

FIG. 2 is a block diagram of a temperature measurement apparatus according to an embodiment of the present disclosure.

FIG. 3 is a diagram for explaining a temperature measurement apparatus according to an embodiment of the present disclosure.

FIG. 4 is an exploded perspective view showing a temperature measurement apparatus according to an embodiment of the present disclosure.

FIG. 5 is a plan view showing a temperature measurement apparatus according to an embodiment of the present disclosure.

FIGS. 6 to 8 are diagrams for explaining a temperature measuring method according to an embodiment of the present disclosure.

FIG. 9 is a diagram for explaining a temperature measurement apparatus according to an embodiment of the present disclosure.

FIG. 10 is a diagram for explaining a temperature measurement apparatus according to another embodiment of the present disclosure.

FIG. 11 is a diagram for explaining a light collector according to an embodiment of the present disclosure.

FIG. 12 is a diagram for explaining a light collector according to an embodiment of the present disclosure.

FIG. 13 is a diagram for explaining a temperature measurement apparatus according to an embodiment of the present disclosure.

FIG. 14 is a diagram for explaining a temperature measurement apparatus disposed in a battery cell according to an embodiment of the present disclosure.

FIG. 15 is a diagram showing temperature distribution of at least one battery cell according to an embodiment of the present disclosure.

FIG. 16 is a diagram for explaining a method of acquiring temperature spectrum information according to an embodiment of the present disclosure.

FIG. 17 is a diagram for explaining intensity information for each wavelength according to an embodiment of the present disclosure.

### BEST MODE

Hereinafter, embodiments related to the present disclosure will be described in more detail with reference to the drawings. The suffixes “module” and “unit” for the components used in the following description are given or used interchangeably in consideration of only the ease of writing the specification, and do not themselves have a meaning or role distinct from each other.

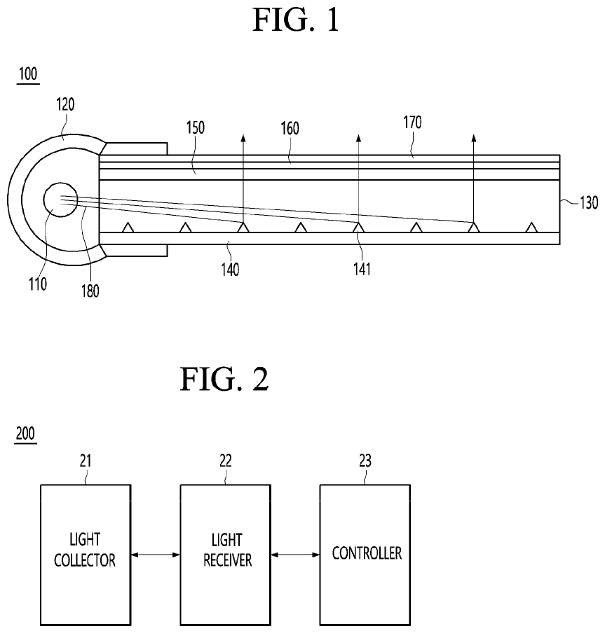

FIG. 1 is a diagram showing a conventional general backlight unit.

A backlight unit 100 is a device that artificially supplies light to implement a screen since an LCD is not capable of emitting light by itself in an LCD TV.

The backlight unit 100 may include a light source 110 that emits light. The light source 110 may include a cold cathode fluorescent lamp (CCFL) or a light emitting diode (LED). The light source unit 110 may be positioned at an edge of the backlight unit 100 and disposed adjacent to a side surface of a light guide plate 130 to be described later to emit light toward the light guide plate 130.

The backlight unit 100 may include a light source cover 120. The light source cover 120 may be disposed to surround the light source 110.

In addition, the backlight unit 100 may include the light guide plate 130. The light guide plate 130 may change a path of light generated from the light source 110 to another side to emit light. The light guide plate 130 may uniformly distribute light incident from the light source 110 over an entire area. In addition, the light guide plate 130 may be formed of a light-transmitting material having a constant refractive index.

The backlight unit 100 may include a reflective member 140. The reflective member 140 is a member for reducing loss of light incident from the light source 110 and may be formed in the form of a film, but is not limited thereto. The reflective member 140 may include an optical pattern part 141. The optical pattern part 141 may diffuse or reflect the light incident from the light source 110 to prevent the light from being concentrated, thereby preventing light leakage, bright lines, or dark lines. A pattern for performing light reflection, light diffusion, light scattering, or light blocking may be formed in the optical pattern part 141.

The backlight unit 100 may include a diffusion sheet 150. The diffusion sheet 150 may re-scatter the light emitted from the light guide plate 130 to cause the light to be emitted evenly.

The backlight unit 100 may include a prism sheet 160. The prism sheet 160 may be a sheet that increases light efficiency and may change side light to front light and collect light that spreads in all directions. Accordingly, the prism sheet 160 may condense the emitted light.

In addition, the backlight unit 100 may include a protective film 170. The protective film 170 may serve to protect the reflective member 140, the diffusion sheet 150, or the prism sheet 160.

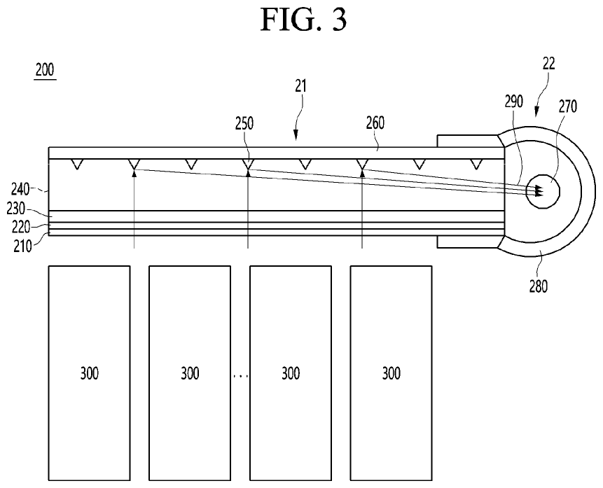

FIG. 2 is a block diagram of a temperature measurement apparatus according to an embodiment of the present disclosure.

A temperature measurement apparatus 200 may be positioned in at least a partial region of at least one surface of at least one battery cell to measure the temperature of at least one battery cell 300. The temperature measurement apparatus 200 may be positioned on at least a partial region of an upper surface of at least one battery cell. In addition, even when the one battery cell 300 has a wide surface as a large-capacity battery cell, the temperature measurement apparatus 200 may be positioned on at least a partial region of at least one surface of the one battery cell 300 to measure the temperature of the battery cell 300. The number of the battery cells 300 may be plural, and the temperature measurement apparatus 200 may be positioned in at least a partial region of at least one surface of the plurality of battery cells to measure the temperature of the plurality of battery cells 300.

The temperature measurement apparatus 200 may include a light collector 21 for collecting electromagnetic waves having a unique wavelength according to thermal energy emitted from at least one battery cell, a light receiver 22 for receiving the collected electromagnetic waves 290, and a controller 23 that obtains temperature spectrum information based on the received electromagnetic waves and checks the temperature of the at least one battery cell 300 based on the obtained temperature spectrum information.

At least one battery cell may be a battery cell included in a battery for an electric vehicle. The battery cell may be a basic unit of a lithium ion battery for charging and discharging electrical energy. A battery cell may include an anode, a cathode, a separator, and an electrolyte in the form of a rectangular aluminum case.

At least one battery cell may be assembled to a predetermined frame to form a battery module in order to be protected from external shock, heat, vibration, and the like. In addition, at least one battery module may be installed in various control and protection systems such as a battery management system or a cooling system to form a battery pack to be installed in an electric vehicle.

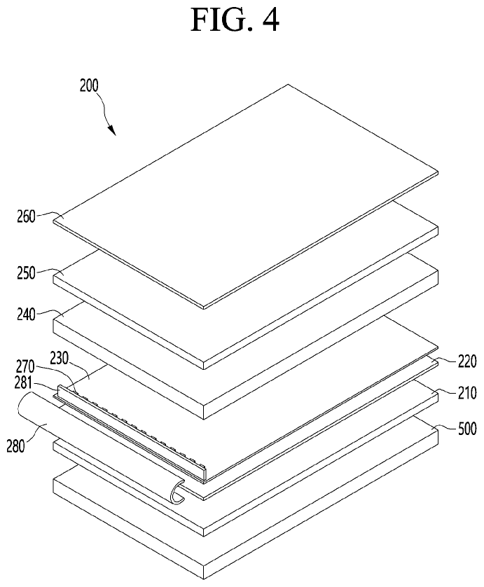

FIG. 3 is a diagram for explaining a temperature measurement apparatus according to an embodiment of the present disclosure.

The temperature measurement apparatus 200 according to the present disclosure may include a configuration formed by borrowing or modifying some or all configurations of the conventional general backlight unit 100 described in FIG. 1. While the backlight unit 100 changes a path of light incident from the light source 110 to another side by the light guide plate 130 and emits light, the temperature measurement apparatus 200 may collect the electromagnetic waves 290 incident to the light guide plate 240 and radiate the same to the light receiver 22.

The temperature measurement apparatus 200 may include the light collector 21 for collecting the electromagnetic wave 290 having a unique wavelength according to thermal energy emitted from the at least one battery cell 300, the light receiver 22 for receiving the collected electromagnetic waves 290, and the controller 23 that obtains temperature spectrum information based on the received electromagnetic waves 290 and checks the temperature of the at least one battery cell 300 based on the obtained temperature spectrum information.

The temperature measurement apparatus 200 may be positioned on one surface of the at least one battery cell 300 to measure the temperature of the at least one battery cell 300. The light collector 21 may be positioned on at least a partial region of one surface of at least one battery cell. For example, the light collector 21 may be positioned above the at least one battery cell 300 to measure the temperature of the at least one battery cell 300.

The light collector 21 may include a protective film 210, a prism sheet 220, a diffusion sheet 230, the light guide plate 240, an optical pattern part 250, and a reflective member 260.

The protective film 210 may protect the light collector 21. The protective film 210 may be made of an acrylic transparent resin, but is not limited thereto. The protective film 210 may protect against damage due to contact with the battery cell 300.

The prism sheet 220 may be a sheet that increases light efficiency and may change front light incident from the battery cell 300 to side light.

The diffusion sheet 230 may re-scatter the light incident on the light guide plate 240 to cause the light to be evenly incident.

When the electromagnetic wave 290 radiated from the at least one battery cell 300 is incident, the light guide plate 240 may change a path of the incident electromagnetic wave 290 to another side to emit light.

For example, the light guide plate 240 may change a path of the electromagnetic wave 290 incident in a substantially vertical direction from the at least one battery cell 300. In addition, the light guide plate 240 may be made of a light-transmitting material having a constant refractive index.

The reflective member 260 may reduce loss of the electromagnetic wave 290 incident on the light guide plate 240. The reflective member 260 may be formed in the form of a film, but is not limited thereto. The reflective member 260 may include an optical pattern part 250. The optical pattern part 250 may diffuse or reflect electromagnetic waves incident from the at least one battery cell 300 to prevent light from being concentrated, thereby preventing light leakage, bright lines, or dark lines. A pattern for performing light reflection, light diffusion, light scattering, or light blocking may be formed in the optical pattern part 250.

The light receiver 22 may include a light receiving sensor 270 or a light receiving cover 280. The light receiving sensor 270 may receive the electromagnetic wave 290 collected by the light collector 21. For example, the light guide plate 240 may change the path of the incident electromagnetic wave 290 toward the light receiving sensor 270, and the light receiving sensor 270 may receive the electromagnetic wave 290 moving along the changed path. The light receiving sensor 270 may be disposed adjacent to the side surface of the light guide plate.

The light receiving sensor 270 may be an infrared sensor. The infrared sensor may refer to a sensor for detecting a physical quantity such as temperature using infrared light and converting the detected physical quantity into an electrical quantity capable of signal processing.

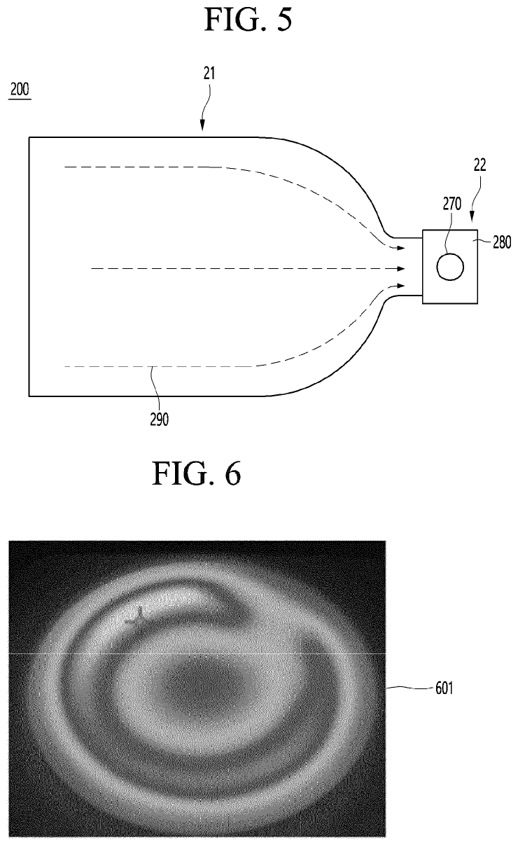

FIG. 4 is an exploded perspective view showing a temperature measurement apparatus according to an embodiment of the present disclosure.

The light receiver 22 may also include the plurality of light receiving sensors 270.

Referring to FIG. 4, the plurality of light receiving sensors 270 may be supported by a light receiving sensor support 281. The plurality of light receiving sensors 270 may be disposed adjacent to one side surface of the light guide plate 240 at a predetermined interval. Therefore, the plurality of light receiving sensors 270 may sufficiently receive the electromagnetic wave 290 collected when the path of the electromagnetic wave 290 radiated from the plurality of battery cells 300 is changed to one side of the light guide plate 240 and light is collected.

The light collector 21 may include a Fresnel lens 500.

The Fresnel lens 500 may be one of condensing lenses, which collects light like a convex lens, but has a reduced thickness. The Fresnel lens 500 may focus the electromagnetic waves emitted from the at least one battery cell 300 to one place and may make the electromagnetic waves concentrated on the light guide plate 240 incident.

The Fresnel lens 500 according to an embodiment may have a greater horizontal or vertical length than the light guide plate 240. Therefore, even when the light guide plate 240 is smaller than an upper area of the at least one battery cell 300, the Fresnel lens 500 may cover the upper area of the at least one battery cell 300, may focus electromagnetic waves emitted from the at least one battery cell 300, and may cause the focused electromagnetic waves to be incident on the light guide plate 240.

In addition, the temperature measurement apparatus according to another embodiment of the present disclosure may include a light collector including the Fresnel lens 500 positioned adjacent to the at least one battery cell 300 and concentrating electromagnetic waves radiated from at least the battery cell 300, and a light receiver including at least one light receiving sensor 270 positioned in a direction in which a focus of the Fresnel lens is formed.

For example, in the temperature measurement apparatus 200, the Fresnel lens 500 may be disposed on an upper surface of the at least one battery cell 300 such that a focus of the Fresnel lens 500 is directed upward. The temperature measurement apparatus 200 may include a light receiver in which the at least one light receiving sensor 270 is located in a direction in which the focus of the Fresnel lens 500 is formed. In this case, the light receiving sensor 270 may be disposed to receive electromagnetic waves concentrated from the Fresnel lens 500. Therefore, the temperature measurement apparatus 200 may measure a temperature by receiving and using electromagnetic waves emitted from the at least one battery cell 300 without the light guide plate 240.

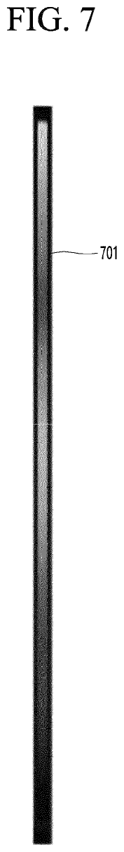

FIG. 5 is a plan view showing a temperature measurement apparatus according to an embodiment of the present disclosure.

The light collector 21 may have a shape of which a width decreases from the opposite side surface of the side surface on which the light receiver 22 is disposed toward the side surface on which the light receiver 22 is disposed.

Referring to FIG. 5, the light collector 21 may have a shape of which a width W is reduced toward a side A on which the light receiver 22 is disposed from the other side B opposite to the side A. Therefore, the electromagnetic wave 290 incident to the light collector 21 may be collected by the light receiver 22 by the shape of the light collector 21 (for example, the shape of the light guide plate 240). Accordingly, the electromagnetic wave 290 radiated from the at least one battery cell 300 may be received with only one light receiving sensor 270. Accordingly, the number of the light receiving sensors 270 may be minimized, the electromagnetic wave 290 may be sufficiently received even with the light receiving sensor 270 having low sensitivity, and the temperature may be measured.

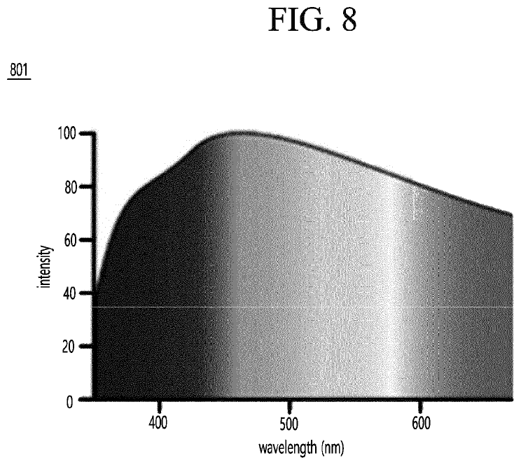

FIGS. 6 to 8 are diagrams for explaining a temperature measuring method according to an embodiment of the present disclosure.

FIG. 6 is a diagram showing temperature distribution of the at least one battery cell 300 according to an embodiment of the present disclosure.

FIG. 6 shows temperature distribution information 601 of one side of the at least one battery cell 300, obtained using an infrared thermal imaging sensor or the like. However, there is a problem in that, in order for the thermal imaging sensor or the like to obtain temperature distribution data as shown in FIG. 6 of the at least one battery cell 300, the temperature of the battery cell 300 needs to be measured at a location where a sufficient distance from the battery cell 300 is ensured.

FIG. 7 is a diagram for explaining a method of acquiring temperature spectrum information according to an embodiment of the present disclosure.

The controller 23 may acquire temperature spectrum information 701 based on electromagnetic waves received by the light receiver 22.

The electromagnetic waves received by the light receiver 22 may be electromagnetic waves having a unique wavelength according to thermal energy emitted from the at least one battery cell 300, and the controller 23 may acquire temperature spectrum information of the received electromagnetic wave.

The controller 23 may measure a temperature in at least a partial region of one surface of at least one battery cell based on the temperature spectrum information.

For example, the controller 23 may obtain intensity information for each wavelength based on temperature spectrum information.

FIG. 8 is a diagram for explaining intensity information for each wavelength according to an embodiment of the present disclosure.

Referring to FIG. 8, the controller 23 may obtain intensity information 801 for each wavelength of an electromagnetic wave received by the light receiver 22.

In general, when a wavelength of an electromagnetic wave radiated from an object is short, the temperature of the object is high because energy is high, and when a wavelength radiated from the object is long, the temperature of the object is low because the energy is low.

The controller 23 may measure the temperature of the at least one battery cell 300 based on the intensity information for each wavelength.

For example, when the controller 23 detects a wavelength intensity less than a preset intensity at a wavelength equal to or less than a preset wavelength based on intensity information for each wavelength, the controller 23 may determine that heat at a temperature less than a reference value is generated from an entire region of the at least one battery cell 300.

For example, when the controller 23 detects a wavelength intensity equal to or greater than a preset intensity at a wavelength equal to or less than a preset wavelength based on the intensity information for each wavelength, the controller 23 may determine that heat at a temperature equal to or greater than a reference value is generated from a predetermined area of the at least one battery cell 300.

Therefore, the temperature measurement apparatus 200 may determine whether heat at a temperature equal to or greater than a reference value is generated from a predetermined area of the at least one battery cell 300 without need to measure the temperature of each of the at least one battery cell 300.

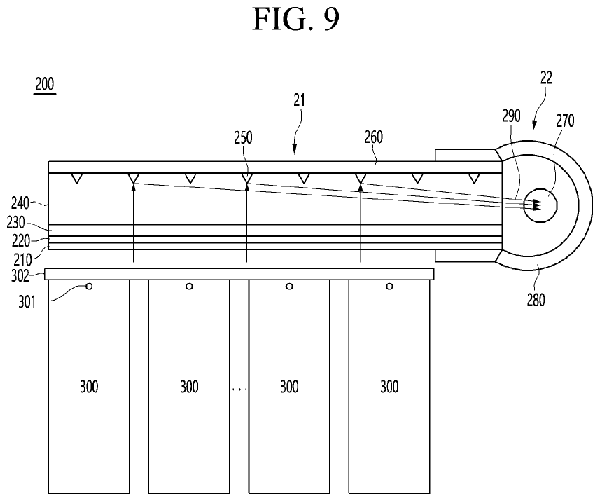

FIG. 9 is a diagram for explaining a temperature measurement apparatus according to an embodiment of the present disclosure.

The at least one battery cell 300 may further include an amplification light source 301 for amplifying an electromagnetic wave having a unique wavelength according to a temperature generated by radiation and incident to the light guide plate 240. The amplifying light source 301 may be positioned between the battery cell 300 and the light collector 21. The amplifying light source 301 may emit infrared light having a wavelength in an infrared region.

The battery cell 300 may include a layer 302 coated with a zion pigment on one surface facing the light collector 21. Zion pigments may be pigments whose color changes with temperature. The layer 302 may be a layer coated with a zion pigment that changes to a predetermined color when the battery cell 300 exceeds a temperature (e.g., 60 degrees) for maintaining stability.

Accordingly, when a reference temperature for maintaining stability is exceeded in a predetermined area of the at least one battery cell 300, the layer 302 changes to a predetermined color (e.g., black) to reduce the amount of the electromagnetic wave incident to the light receiver 240, the strength of the electromagnetic wave received by the light receiver 22 may be reduced. In this case, when the intensity of the electromagnetic wave received by the light receiver 22 is equal to or less than a reference value, the controller 23 may also determine that the reference temperature for maintaining stability in a predetermined area of the at least one battery cell 300 is exceeded.

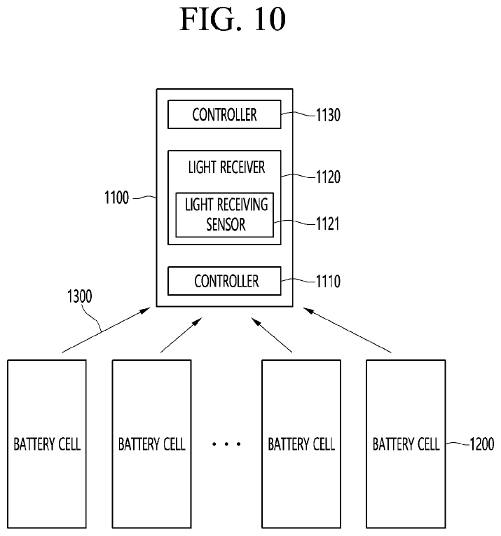

FIG. 10 is a diagram for explaining a temperature measurement apparatus according to another embodiment of the present disclosure.

A temperature measurement apparatus 1100 may be positioned at a predetermined distance from one side of at least one battery cell to measure the temperature of at least one battery cell 1200.

The temperature measurement apparatus 1100 may be positioned at a predetermined distance away from at least a partial region on one side of at least one battery cell to measure the temperature of the at least one battery cell 1200. The separation distance may be a focal length of a light collector 1110 that enables the temperature measurement apparatus 1100 to collect the electromagnetic waves 1300 to measure the temperature of at least a partial region of one surface of at least one battery cell.

The temperature measurement apparatus 1100 may be positioned at a predetermined distance from at least a partial region on one surface of at least one battery cell.

In addition, even when the one battery cell 1200 has a wide surface as a large-capacity battery cell, the temperature measurement apparatus 1100 may be positioned at a predetermined distance from one surface of the one battery cell 1200 to measure the temperature of the battery cell 1200.

The temperature measurement apparatus 1100 may include the light collector 1110 for collecting the electromagnetic waves 1300 having a unique wavelength according to thermal energy emitted from at least one battery cell, a light receiver 1120 for receiving the collected electromagnetic waves 1300, and a controller 1130 that obtains temperature spectrum information based on the received electromagnetic waves and checks the temperature of the at least one battery cell 1200 based on the obtained temperature spectrum information.

The light collector 1110 may collect the electromagnetic waves 1300 emitted from one or more battery cells 1200 to the light receiver 1120.

The light receiver 1120 may include a light receiving sensor 1121. The light receiving sensor 1121 may receive the electromagnetic waves 1300 collected by the light collector 1110. For example, the light collector 1110 may change a path of the incident electromagnetic waves 1300 to face the light receiving sensor 1121, and the light receiving sensor 1121 may receive the electromagnetic waves 1300 moving along the changed path. The light receiving sensor 1121 may be an infrared sensor. The infrared sensor may refer to a sensor for detecting a physical quantity such as temperature using infrared light and converting the detected physical quantity into an electrical quantity capable of signal processing.

The at least one battery cell 1200 may be a battery cell included in a battery for an electric vehicle. The battery cell 1200 may be a basic unit of a lithium-ion battery for charging and discharging electrical energy. The battery cell 1200 may include an anode, a cathode, a separator, and an electrolyte in the form of a rectangular aluminum case. Without being limited thereto, the battery cell 1200 may be configured in various forms such as a cylindrical case and a polymer pouch.

At least one battery cell may be assembled to a predetermined frame to form a battery module in order to be protected from external shock, heat, vibration, and the like. In addition, at least one battery module may be installed in various control and protection systems such as a battery management system or a cooling system to form a battery pack to be installed in an electric vehicle.

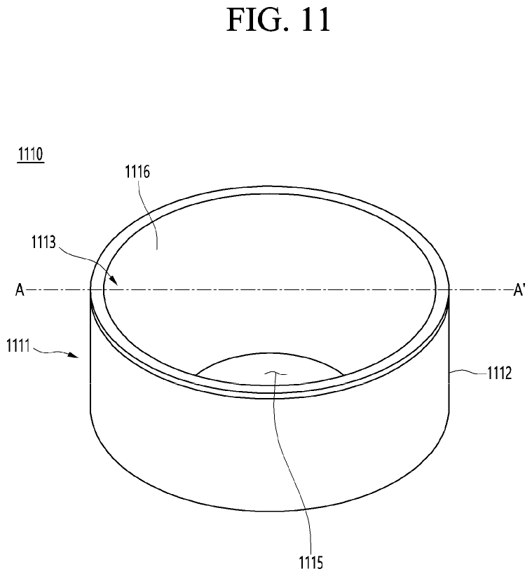

FIG. 11 is a diagram for explaining a light collector according to an embodiment of the present disclosure.

The light collector 1110 may include a condensing lens 1111 for collecting the electromagnetic waves 1300 emitted from a battery cell 1200. The condensing lens 1111 may collect the emitted electromagnetic waves 1300 at close to about 180 degrees. For example, the condensing lens 1111 may condense the electromagnetic waves 1300 at about 178 degrees, which is greater than a wide angle (or viewing angle) of a general lens.

The condensing lens 1111 may have a cylindrical shape in which upper and lower portions are opened and penetrated. For example, an upper portion of the condensing lens 1111 may be opened to form a first opening 1114, and a lower portion may be opened to form a second opening 1115. The first opening 1114 and the second opening 1115 may penetrate each other. The condensing lens 1111 may include a lens body 1112 made of a material through which light is capable of passing. In the condensing lens 1111, an inclined portion 1113 may be formed to be narrowed inward on a central line where electromagnetic waves are condensed from the outside. That is, the condensing lens 1111 may have a truncated cone-shaped through hole formed therein. Accordingly, the electromagnetic waves 1300 emitted from at least one battery cell 1200 may be incident to the light receiver 1120 through the through hole. In addition, the inclined portion 1113 may have an inclined surface that is depressed inward from the first opening 1114 to the second opening 1115. The first opening 1114 may have a larger diameter than the second opening 1115.

The inclined portion 1113 may have a coating portion 1116 formed on a surface of a paint having a predetermined reflectivity. In this case, the paint may be a non-ferrous metal paint such as silver, aluminum, gold, chrome, stainless, brass, zinc, or magnesium alloy.

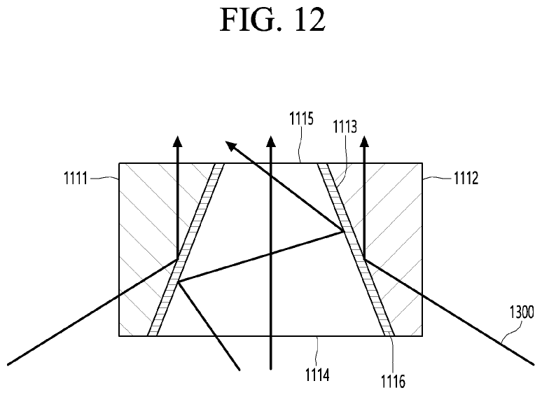

FIG. 12 is a diagram for explaining a light collector according to an embodiment of the present disclosure.

FIG. 12 is a cross-sectional view taken along A-A′ of the condensing lens 1111 of FIG. 11, and is a diagram for explaining an example in which the electromagnetic waves 1300 emitted from the at least one battery cell 1200 are collected.

The condensing lens 1111 of the light collector 1110 may be disposed in such a way that the first opening 1114 having a larger diameter than the second opening 1115 faces the at least one battery cell 1200. The light receiver 1120 may be positioned at a side of the second opening 1115. An inclination angle of the inclined portion 1113 may be determined based on an angle of view of a sensor receiving the electromagnetic waves 1300.

The condensing lens 1111 may condense the electromagnetic waves 1300 incident on the first opening 1114 through the second opening 1115. The electromagnetic waves 1300 incident on the first opening 1114 may be focused on the second opening 1115 by the inclined portion 1113 and the coating portion 1116. The light receiver 1120 may be disposed at a side of the second opening 1115. Accordingly, the light receiver 1120 may receive the electromagnetic waves 1300 condensed by the second opening 1115. The second opening 1115 may come into contact with a lens surface of the light receiving sensor 1121 of the light receiver 1120. Accordingly, the electromagnetic waves 1300 condensed by the second opening 1115 may be incident to a lens of the light receiving sensor 1121. A lens of the light receiving sensor 1121 may be configured to direct the incident electromagnetic waves 1300 to the sensor of the light receiving sensor 1121.

The condensing lens 1111 may condense the electromagnetic waves 1300 incident on the lens body 1112 toward a side of the second opening 1115.

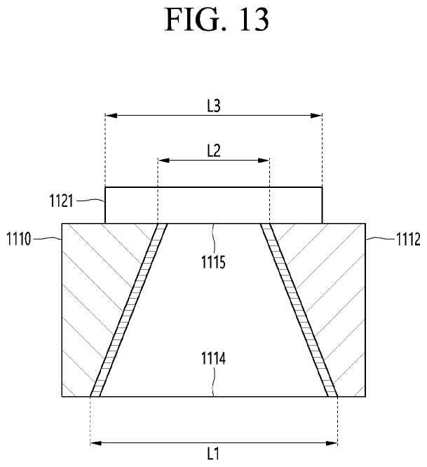

FIG. 13 is a diagram for explaining a temperature measurement apparatus according to an embodiment of the present disclosure.

FIG. 13 shows the light receiving sensor 1121 disposed on the second opening 1115 of the light collector 1110.

The light receiving sensor 1121 may receive electromagnetic waves condensed by the light collector 1110. A diameter L3 of a light receiving range in which the light receiving sensor 1121 is capable of receive electromagnetic waves may be less than or equal to a diameter L1 of the first opening 1114 and equal to or greater than a diameter L2 of the second opening 1115.

Accordingly, the light receiving sensor 1121 may have a light receiving range for receiving not only electromagnetic waves incident through the first opening 1114 and condensed through the second opening 1115 but also electromagnetic waves incident into the condensing lens body 1112 and refracted or reflected.

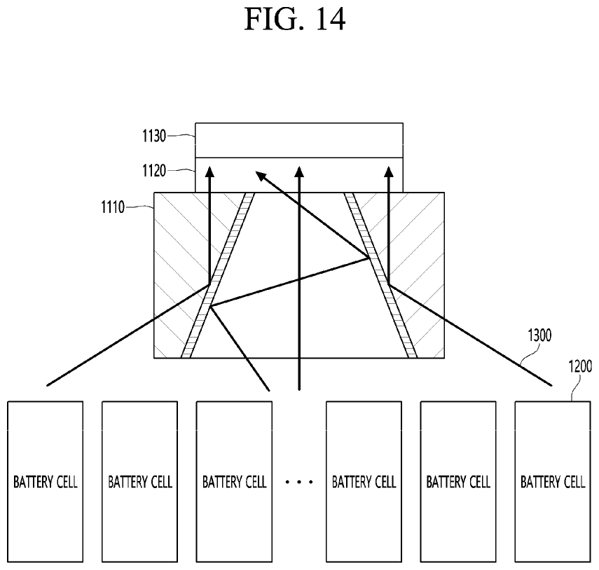

FIG. 14 is a diagram for explaining a temperature measurement apparatus disposed in a battery cell according to an embodiment of the present disclosure.

The electromagnetic waves 1300 having a unique wavelength radiated by thermal energy generated by the at least one battery cell 1200 may be collected by the light collector 1110 toward the light receiver 1120. The light receiver 1120 may receive the condensed electromagnetic waves 1300. The controller 1130 may obtain temperature spectrum information based on electromagnetic waves received by the light receiver 1120.

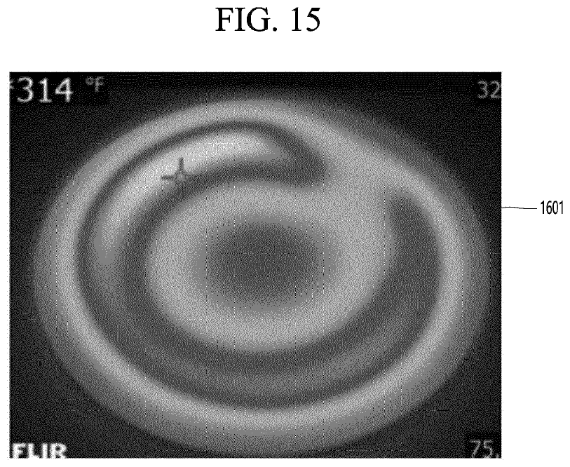

FIGS. 15 to 17 are diagrams for explaining a temperature measurement method according to an embodiment of the present disclosure.

FIG. 15 is a diagram showing temperature distribution of the at least one battery cell 1200 according to an embodiment of the present disclosure.

FIG. 15 shows temperature distribution information 1601 of one surface of the at least one battery cell 1200, obtained using an infrared thermal imaging sensor or the like. However, there is a problem in that, in order for the thermal imaging sensor or the like to obtain temperature distribution data as shown in FIG. 15 of the at least one battery cell 1200, the temperature of the battery cell 300 needs to be measured at a location where a sufficient distance from the battery cell 1200 is ensured. On the other hand, the temperature measurement apparatus 1100 for measuring the temperature of the at least one battery cell 1200 according to an embodiment of the present disclosure may measure whether at least a partial region of the at least one battery cell 1200 exceeds a specific temperature, and may not necessarily acquire temperature distribution information of the battery cell 1200.

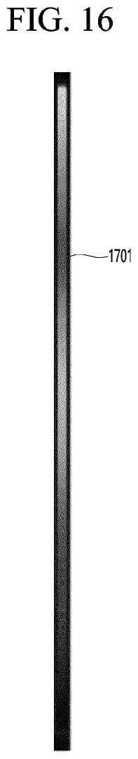

FIG. 16 is a diagram for explaining a method of acquiring temperature spectrum information according to an embodiment of the present disclosure.

The controller 1130 may acquire temperature spectrum information 1701 based on electromagnetic waves received by the light receiver 1120.

The electromagnetic waves received by the light receiver 1120 may be electromagnetic waves having a unique wavelength according to thermal energy emitted from the at least one battery cell 1200, and the controller 1130 may acquire temperature spectrum information of the received electromagnetic waves.

The controller 1130 may measure a temperature in at least a partial region of one surface of at least one battery cell based on the temperature spectrum information.

For example, the controller 1130 may obtain intensity information for each wavelength based on temperature spectrum information. The intensity information for each wavelength may be temperature generation area information on an area of temperature in the at least one battery cell 1200.

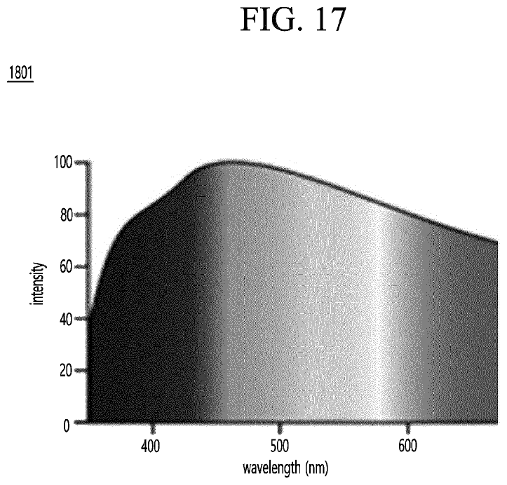

FIG. 17 is a diagram for explaining intensity information for each wavelength according to an embodiment of the present disclosure.

Referring to FIG. 17, the controller 1130 may acquire intensity information for each wavelength 1801 of electromagnetic waves received by the light receiver 1120.

In general, when a wavelength of an electromagnetic wave radiated from an object is short, the temperature of the object is high because energy is high, and when a wavelength radiated from the object is long, the temperature of the object is low because the energy is low.

The controller 1130 may measure the temperature of the at least one battery cell 1200 based on the intensity information for each wavelength. For example, the controller 1130 may measure the temperature of the at least one battery cell 1200 by determining whether a wavelength of a specific temperature is generated based on the intensity information for each wavelength.

For example, when the controller 1130 detects a wavelength intensity less than a preset intensity at a wavelength equal to or less than a preset wavelength based on the intensity information for each wavelength, the controller 1130 may determine that heat at a temperature less than a reference value is generated from a predetermined area of the at least one battery cell 1200.

In addition, when the controller 1130 detects a wavelength intensity equal to or greater than a preset intensity at a wavelength equal to or less than a preset wavelength based on the intensity information for each wavelength, the controller 1130 may determine that heat at a temperature equal to or greater than a reference value is generated from a predetermined area of the at least one battery cell 1200.

Therefore, the temperature measurement apparatus 1100 may determine whether heat at a temperature equal to or greater than a reference value is generated from a predetermined area of the at least one battery cell 1200 without need to measure the temperature of each of the at least one battery cell 1200.

The above description is merely an example of the technical spirit of the present disclosure, and various modifications and variations may be made to those skilled in the art without departing from the essential characteristics of the present disclosure.

Therefore, the embodiments disclosed in the present disclosure are not intended to limit the technical spirit of the present disclosure, but to explain, and the scope of the technical spirit of the present disclosure is not limited by these embodiments.

The scope of the present disclosure needs to be construed according to the following claims, and all technical spirits within the scope equivalent thereto need to be construed as being included in the scope of the present disclosure.

1. A temperature measurement apparatus comprising:
a light collector positioned in at least a partial region of one surface of at least one battery cell and configured to collect an electromagnetic wave radiated from the at least one battery cell;
a light receiver configured to receive the collected electromagnetic wave; and
a controller configured to measure a temperature of at least a partial region of one surface of the at least one battery cell based on the received electromagnetic wave.

2. The temperature measurement apparatus of claim 1, wherein the at least one battery cell is a plurality of battery cells.

3. The temperature measurement apparatus of claim 1, wherein the controller acquires temperature spectrum information based on the received electromagnetic wave, and measures a temperature of at least a partial region of one surface of the at least one battery cell based on the temperature spectrum information.

4. The temperature measurement apparatus of claim 1, wherein the light collector includes a light guide plate on which the electromagnetic wave radiated from the at least one battery cell is incident and that is configured to change a path of the incident electromagnetic wave to the light receiver.

5. The temperature measurement apparatus of claim 4, wherein the light collector includes a reflective member disposed on a surface opposite to a surface on which the electromagnetic wave is incident and configured to reflect or diffuse the electromagnetic wave.

6. The temperature measurement apparatus of claim 4, wherein the light receiver includes at least one light receiving sensor disposed on one side surface of the light guide plate and configured to detect an infrared region of the electromagnetic wave.

7. The temperature measurement apparatus of claim 6, wherein the light receiver includes the plurality of light receiving sensors, and the plurality of light receiving sensors are disposed on one side surface of the light guide plate at a predetermined interval.

8. The temperature measurement apparatus of claim 4, wherein the light collector further includes a Fresnel lens positioned closer to the at least one battery cell than the light guide plate and configured to concentrate the electromagnetic wave radiated from the at least one battery cell.

9. The temperature measurement apparatus of claim 8, wherein the Fresnel lens has a greater horizontal or vertical length than the light guide plate.

10. The temperature measurement apparatus of claim 4, wherein the light collector has a shape of which a width decreases from an opposite side to a side at which the light receiver is disposed toward a side at which the light receiver is disposed.

11. The temperature measurement apparatus of claim 10, wherein the light receiver includes one light receiving sensor disposed on a side surface at which the width of the light collector decreases and configured to detect an infrared region of the electromagnetic wave.

12. The temperature measurement apparatus of claim 4, wherein the controller acquires intensity information for each wavelength based on the temperature spectrum information, and when a wavelength intensity equal to or greater than a preset intensity is detected at a wavelength equal to or less than a preset wavelength based on the intensity information for each wavelength, the controller determines that heat at a temperature equal to or greater than a reference value is generated from at least a partial region of the at least one battery cell.

13. The temperature measurement apparatus of claim 1, wherein the light collector includes a Fresnel lens positioned close to the at least one battery cell and configured to concentrate the electromagnetic wave radiated from the at least one battery cell; and
wherein the light receiver includes at least one light receiving sensor positioned in a direction in which a focus of the Fresnel lens is formed.
